(19) United States
(12) Patent Application Publication
(10) Pub. No.: US 2013/0160041 A1
(43) Pub. Date: Jun. 20, 2013

(54) SYSTEM, DIGITAL BROADCASTING RECEIVING APPARATUS, AND INFORMATION TERMINAL APPARATUS

(71) Applicant: Hitachi Consumer Electronics Co., Ltd., Tokyo (JP)

(72) Inventors: Kazuhiko YOSHIZAWA, Yokohama (JP); Hideo NISHIJIMA, Hitachinaka (JP)

(73) Assignee: HITACHI CONSUMER ELECTRONICS CO., LTD., Tokyo (JP)

(21) Appl. No.: 13/710,635

(22) Filed: Dec. 11, 2012

(30) Foreign Application Priority Data
Dec. 14, 2011 (JP) 2011-272918

(51) Int. Cl. H04N 21/431

(52) U.S. Cl. CPC H04N 21/431
USPC 725/14

(57) ABSTRACT

A technique capable of performing a more preferable program recommendation is provided. In a system including a digital broadcasting receiving apparatus and an information terminal apparatus, information regarding viewing programs of the digital broadcasting receiving apparatus is recorded into the information terminal apparatus. On the basis of the information regarding the recorded viewing programs, in the digital broadcasting receiving apparatus or the information terminal apparatus, information of programs to be recommended to the user is selected from program information of programs which are scheduled to be broadcasted in future and is displayed.

### INCORPORATION BY REFERENCE

The present application claims priority from Japanese application JP2011-272918 filed on Dec. 14, 2011, the content of which is hereby incorporated by reference into this application.

### BACKGROUND OF THE INVENTION

The invention relates to a program recommending technique.

Owing to digitization and multi-channel of a broadcasting, the number of programs which can be viewed in a general home is increasing. A video apparatus corresponding to a digital broadcasting, for example, a digital television or the like often has means such as an electronic program table or the like for enabling the user to easily select a desired program. Further, in recent years, an apparatus having such a program recommending function that keywords such as name of the performer, genre information, and the like are extracted from the programs which were viewed by the user in the past, a database of the keywords to which priorities were allocated is formed, and for the latest program information, a result of a search performed on the basis of the keywords with the priorities is provided in advance as recommended programs to the user has also been realized as a product.

In the above program recommending function, in the case where one television receiver is shared by a plurality of users like a case where a family is watching one program together or the like, a program recommendation based on the sum of favorites of all users, so that the recommended programs based on specific personal favorites are not obtained. As a method of identifying a person who is watching the TV and performing the program recommendation according to the personal favorites under such a situation, there is a technique disclosed in the Official Gazette of JP-A-2007-214869.

According to the technique disclosed in the Official Gazette of JPA-2007-214869, the presence or absence of use of a subtitle function which the digital TV has is used as means for identifying the person who is watching the TV shared by a plurality of users. That is, for example, in the case where the user having an auditory disorder exists among the users who share the TV, it is determined that the user is watching the TV on the basis of a use situation of the subtitle function.

However, when such means is used, there is a case where the person cannot be certainly identified. Further, even when there is a single user, if a digital TV different from the digital TV which is ordinarily used is used, there is such a problem that a preferable program recommendation cannot be obtained, or the like.

### SUMMARY OF THE INVENTION

It is an object of the invention to provide a technique which can perform a more preferable program recommendation.

To solve the above problem, according to a preferred embodiment of the invention, there is provided a system including a digital broadcasting receiving apparatus and an information terminal apparatus, wherein information regarding a viewing program of the digital broadcasting receiving apparatus is recorded into the information terminal apparatus, and in the digital broadcasting receiving apparatus or the information terminal apparatus, on the basis of the recorded information regarding the viewing program, information of a program to be recommended to the user is selected from program information of programs which will be broadcasted in future and the selected information is displayed.

By using the technique of the invention, the more preferable program recommendation can be performed.

Other objects, features and advantages of the invention will become apparent from the following description of the embodiments of the invention taken in conjunction with the accompanying drawings.

### BRIEF DESCRIPTION OF THE DRAWINGS

FIG. 1A is a block diagram showing an example of a program recommending apparatus and an information terminal apparatus according to the embodiment 1 of the invention;

FIG. 1B is a block diagram showing an example of a program recommending apparatus and an information terminal apparatus according to the embodiment 1 of the invention;

FIG. 2 is an explanatory diagram of an example of a construction of a program recommending system according to the embodiment 1 of the invention;

FIG. 3 is an explanatory diagram of an example of a database stored in the information terminal apparatus according to the embodiment 1 of the invention;

FIG. 4 is an explanatory diagram of an example of a process for calculating the sum of the storage viewing information regarding a plurality of users in the program recommending system according to the embodiment 1 of the invention;

FIG. 5 is an explanatory diagram of an example of the construction of the program recommending system including the information terminal apparatuses to which a remote control application according to the embodiment 1 of the invention has been applied;

FIG. 6 is an explanatory diagram of an example of a process for adding a weight in a calculation of the sum of the storage viewing information regarding a plurality of users in the program recommending system according to the embodiment 1 of the invention;

FIG. 7 is an explanatory diagram of an example of another construction of the program recommending system according to the embodiment 1 of the invention;

FIG. 8A is a block diagram showing an example of a program recommending apparatus and an information terminal apparatus according to the embodiment 2 of the invention;

FIG. 8B is a block diagram showing an example of a program recommending apparatus and an information terminal apparatus according to the embodiment 2 of the invention;

FIG. 9A is a block diagram showing an example of a program recommending apparatus and an information terminal apparatus according to the embodiment 3 of the invention;

FIG. 9B is a block diagram showing an example of a program recommending apparatus and an information terminal apparatus according to the embodiment 3 of the invention;

FIG. 10 is a block diagram showing an example of a program recommending apparatus according to the embodiment 4 of the invention;

FIG. 11 is an explanatory diagram of an example of a favorite presuming process in the embodiment 4 of the invention;

FIG. 12 is a block diagram showing an example of an information terminal apparatus according to the embodiment 5 of the invention; and

FIG. 13 is a block diagram showing an example of an information terminal apparatus according to the embodiment 6 of the invention.

### DESCRIPTION OF THE EMBODIMENTS

Examples of embodiments of the invention will now be described hereinbelow with reference to the drawings.

### Embodiment 1

The embodiment 1 of the invention will now be described.

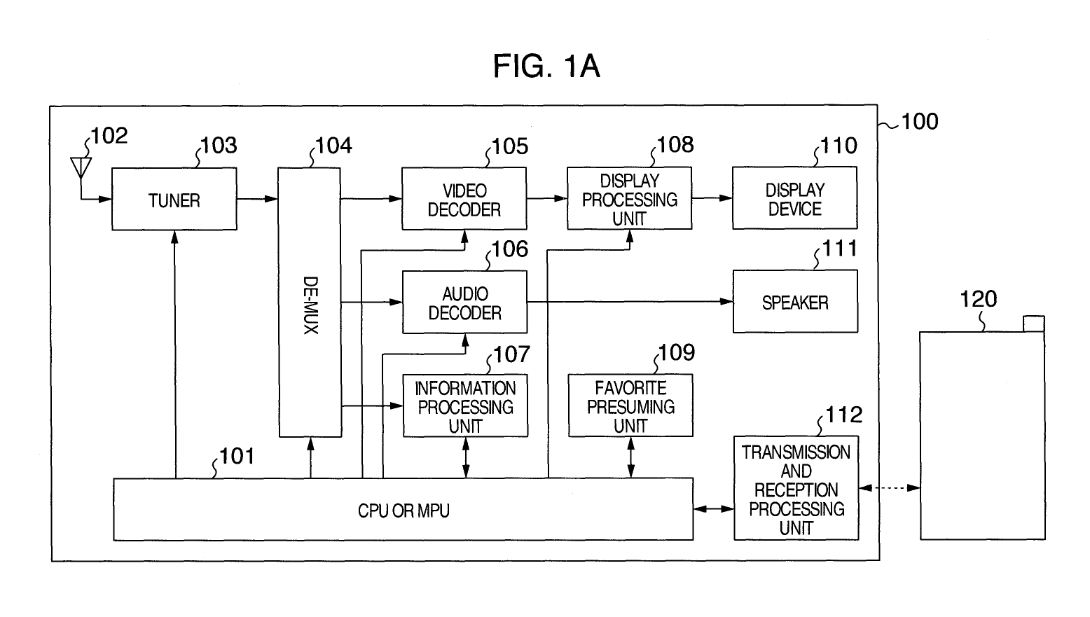

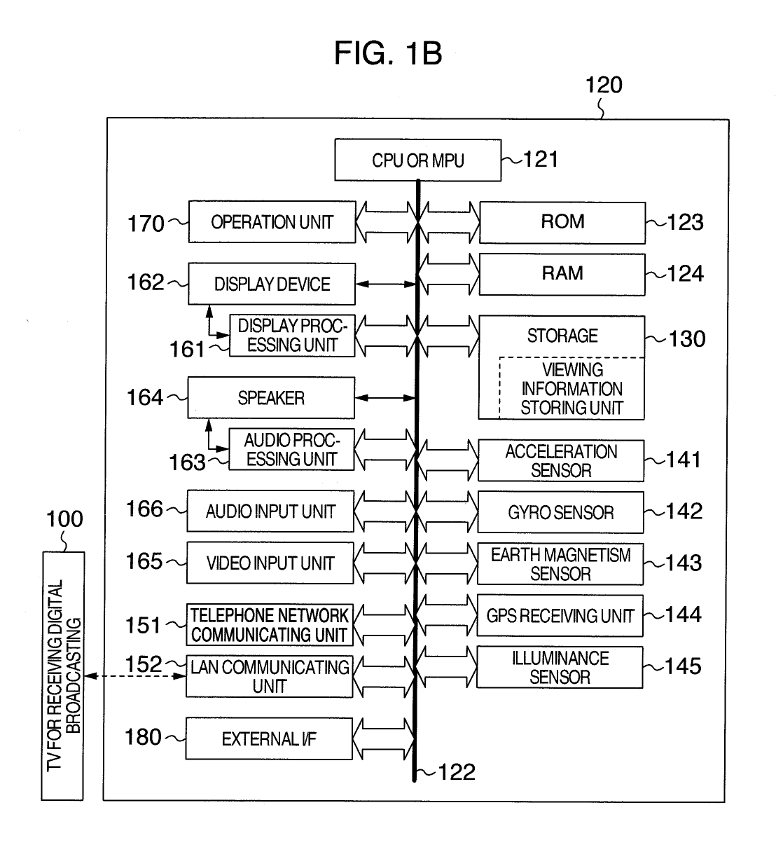

FIGS. 1A and 1B are explanatory diagrams of a program recommending system including a program recommending apparatus (100) and an information terminal apparatus (120) of the invention. In the example of FIGS. 1A and 1B, the program recommending apparatus is constructed as a television for receiving a digital broadcasting. In the diagrams, reference numeral 101 denotes a CPU or MPU; 102 an antenna; 103 a tuner; 104 a de-multiplexer; 105 a video decoder; 106 an audio decoder; 107 an information processing unit; 108 a display processing unit; 109 a favorite presuming unit; 110 a display device; 111a speaker; and 112 a transmission and reception processing unit on the side of the television for receiving a digital broadcasting. Reference numeral 121 denotes a CPU or MPU for controlling the whole mobile information terminal 120. The CPU 121 has a rewritable ROM (Read Only Memory) 123 for storing a program and a RAM (Random Access Memory) 124 serving as a work area. The ROM 123 and RAM 124 may be constructed integratedly with the CPU 121. Reference numeral 122 denotes a system bus for transmitting and receiving data to/from each unit of the system. Reference numeral 130 denotes a storage for storing setting information and personal data of the mobile information terminal 120, downloaded applications, and the like. The storage 130 is constructed by a flash memory, an HDD (Hard Disc Drive), or the like. Reference numeral 141 denotes an acceleration sensor; 142 a gyro sensor; 143 an earth magnetism sensor; 144 a GPS (Global Positioning System) receiving unit; 145 an illuminance sensor; 151a mobile unit telephone network communicating unit for controlling communication with a mobile unit telephone network; and 152 a transmission and reception processing unit on the side of the mobile information terminal for controlling wireless or wired communication with a network such as Internet or the like. Reference numeral 161 denotes a display processing unit; 162 a display device; 163 an audio processing unit; 164 a speaker; 165 a video input unit; 166 an audio input unit; 170 an operation unit for controlling an input which is performed by a touch panel or a plurality of keys; and 180 an external interface unit for performing data communication or the like with an external memory device.

The foregoing constructions are merely shown as an example and it is not always necessary to provide all of the constructions illustrated in the diagrams. In the mobile information terminal 120 of the embodiment, it is assumed that the program stored in the ROM 123 can be updated by downloading a new program from a server through the mobile unit network communicating unit 151 or the transmission and reception processing unit 152 on the mobile information terminal side. Further, in the mobile information terminal 120 of the embodiment, it is assumed that a new application program can be downloaded from the server through the mobile unit network communicating unit 151 or the transmission and reception processing unit 152 on the mobile information terminal side and stored into the storage 130. The new application program which was downloaded from the server and stored into the storage 130 is developed into the RAM 124 and executed, so that a function of the mobile information terminal 120 can be expanded.

After a broadcasting wave of the digital broadcasting was received by the antenna 102, it is inputted to the tuner 103. The tuner 103 extracts a signal of a channel selected by the user from the broadcasting wave received by the antenna 102 and de-modulates into a TS (Transport Stream) signal. The TS signal is constructed by video data, audio data, and associated information data which were respectively packetized, and they are de-multiplexed by the de-multiplexer 104, respectively. The de-multiplexed video data is outputted to the video decoder 105, the de-multiplexed audio data is outputted to the audio decoder 106, and the de-multiplexed associated information data is outputted to the information processing unit 107, respectively.

The video decoder 105 decodes the video data outputted from the de-multiplexer 104 and outputs as a video signal to the display processing unit 108. The display processing unit 108 executes a format conversion, a superimposing process of a menu and another OSD (On Screen Display) signal, and the like to the inputted video signal in accordance with the necessity and outputs the obtained signal to the display device 110. The display device 110 is, for example, a video display device such as a liquid crystal panel or the like, displays the video signal inputted from the display processing unit 108, and provides to the user. The audio decoder 106 decodes the audio data outputted from the de-multiplexer 104 and outputs as an audio signal to the speaker 111. The information processing unit 107 processes the associated information data outputted from the de-multiplexer 104. The CPU 101 is, for example, a microcomputer or the like and controls each unit of the television 100 for receiving the digital broadcasting in the embodiment.

In the ordinary viewing operation, the CPU 101 controls the tuner 103 and extracts a signal of a desired channel by a tuning instruction made by operating a remote controller or the like by the user. On the basis of the control of the CPU 101, the information processing unit 107 obtains program information such as program name, genre, name of the performer, and the like from the associated information data of the selected channel. Further, the CPU 101 executes a process for transmitting the program information obtained in the information processing unit 107 as viewing information to the mobile information terminal 120 through the transmission and reception processing unit 112 on the side of the television for receiving the digital broadcasting. On the other hand, on the mobile information terminal 120 side, on the basis of the instructions of the CPU 121, such a process that the viewing information transmitted from the television 100 for receiving the digital broadcasting is received by the transmission and reception processing unit 152 on the mobile information terminal side and is properly stored into a viewing information storing unit in the storage 130 is executed.

The “viewing information” used here denotes information for discriminating the program viewed by the user.

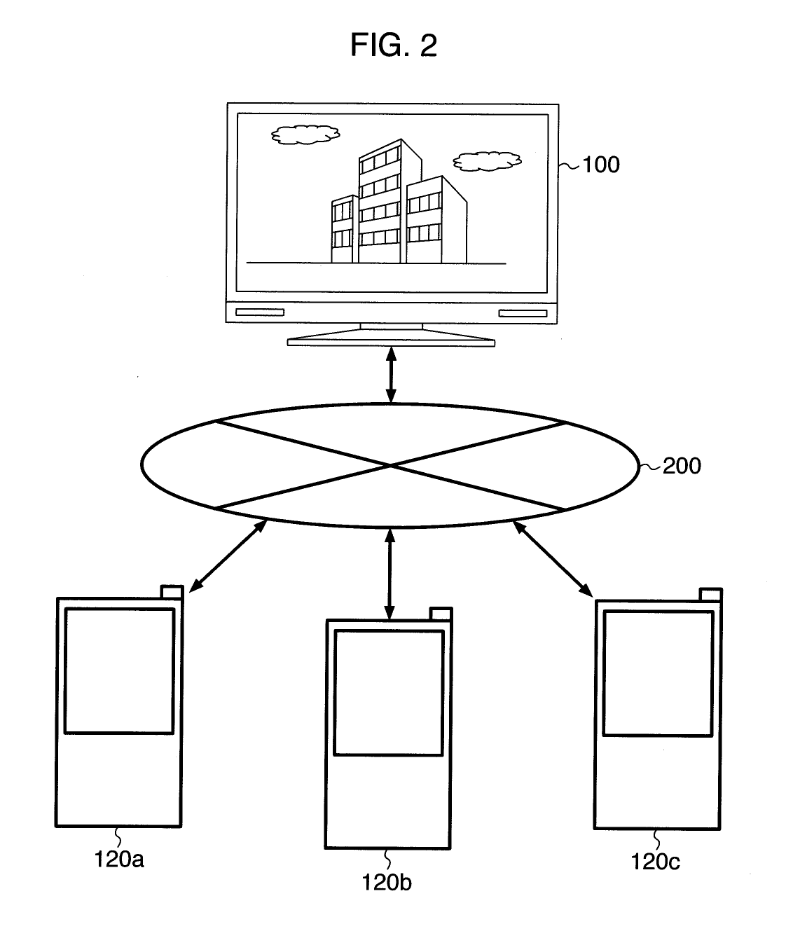

It is now assumed that the communication between the television 100 for receiving the digital broadcasting and the mobile information terminal 120 is performed by, for example, short range wireless communication or the like. It is desirable to process so as to transmit the viewing information only to the mobile information terminals existing at such a distance that the television 100 for receiving the digital broadcasting can be viewed (for example, existing in the same room as that of the television 100 for receiving the digital broadcasting). FIGS. 1A and 1B illustrate the example in which the television 100 for receiving the digital broadcasting and the mobile information terminal 120 make communication in a one-to-one relational manner. However, for example, if a plurality of mobile information terminals exist within a range of a distance where the television 100 for receiving the digital broadcasting can be viewed, that is, in the case of an example as shown in FIG. 2, through a network 200 formed by the short range wireless communication, the television 100 for receiving the digital broadcasting transmits the viewing information to each of a plurality of mobile information terminals 120a, 120b, and 120c existing within the range of a distance where the television 100 for receiving the digital broadcasting can be viewed.

The network 200 for connecting the television 100 for receiving the digital broadcasting and the plurality of mobile information terminals 120a, 120b, and 120c may be, for example, a public communication line network such as Internet. In this case, the television 100 for receiving the digital broadcasting and the plurality of mobile information terminals 120a, 120b, and 120c are mutually connected by an Internet protocol or the like. In this case, since it is difficult to perform a connection limitation by the distance (in other words, even a mobile information terminal which does not exist within the range of the distance where the television 100 for receiving the digital broadcasting can be viewed can be connected), it is sufficient that a recognizing process or the like is preliminarily executed and the viewing information is transmitted only to the mobile information terminal which has established the bidirectional communication with the television 100 for receiving the digital broadcasting. It is also possible to construct so that the recognizing process is executed even in the case of the short range wireless communication.

The process for transmitting the viewing information to the mobile information terminal 120, that is, such a process that is executed in the television 100 for receiving the digital broadcasting is not executed just after the tuner 103 executed the tuning operation, but it is desirable to execute such a process in the case where, for example, the viewing was continued for a period of time of 50% or longer than a broadcasting time duration of the selected program (in a program whose broadcasting time duration is equal to 60 minutes, the case where the program was viewed for about 30 minutes or longer), or the like. Although the timing for executing the process for transmitting the viewing information to the mobile information terminal 120 has been set to the timing of “the viewing was continued for a period of time of 50% or longer than the broadcasting time duration of the selected program” in the above example, it may be set to “40% or longer” or “60% or longer”. However, if such a percentage is set to a too small numerical value, in spite of a fact that the program is hardly viewed, it is regarded that the program has been viewed, so that its viewing information is stored into the viewing information storing unit in the storage 130. On the contrary, if such a percentage is set to a too large numerical value, in spite of a fact that a main part of the program such as a drama or the like has completely been viewed, since a part of the last portion of the program is not viewed yet, it is regarded that the program itself is not viewed, so that its viewing information is not stored into the viewing information storing unit in the storage 130. Consequently, there is a possibility that the accurate presumption cannot be performed at the time of a process for presuming a favorite regarding the program viewing on the basis of the viewing information. Therefore, it is desirable to set such a percentage to a proper numerical value which is not too small and is not too large. In the case of continuously viewing a plurality of programs in the same channel, the foregoing process (the transmitting process of the viewing information is executed in the case where the viewing was continued for a period of time of, for example, 50% or longer than the broadcasting time duration of the program) is executed to each program.

As a process for storing the program information obtained in the information processing unit 107 as viewing information into the viewing information storing unit in the storage 130 of the mobile information terminal 120, for example, it is also possible to construct in such a manner that the CPU 101 transmits the viewing information obtained in the information processing unit 107 as it is as viewing information to the mobile information terminal 120 side and, on the mobile information terminal 120 side, by the control of the CPU 121 of the mobile information terminal 120, keywords are extracted from the received viewing information and stored into the viewing information storing unit in the storage 130. It is also possible to construct in such a manner that the CPU 101 extracts the keywords from the program information obtained in the information processing unit 107 and transmits the extracted keywords as viewing information to the mobile information terminal 120 side, and on the mobile information terminal 120 side, by the control of the CPU 121 of the mobile information terminal 120, the received viewing information is stored into the viewing information storing unit in the storage 130. In the embodiment, it is assumed that a process is executed in such a manner that the CPU 101 transmits the keywords extracted from the program information obtained in the information processing unit 107 as viewing information to the mobile information terminal 120 side together with the program name, and on the mobile information terminal 120 side, by the control of the CPU 121 of the mobile information terminal 120, the received viewing information (keywords+program name) is stored into the viewing information storing unit in the storage 130.

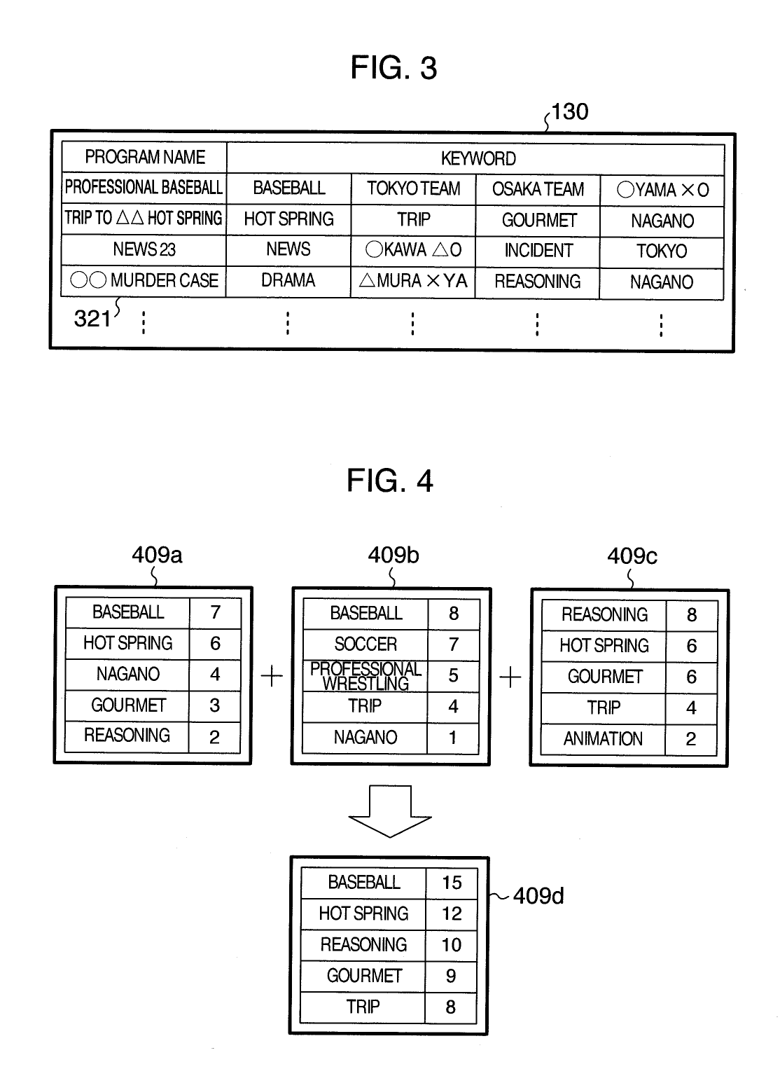

FIG. 3 shows an example of a database constructed in the viewing information storing unit in the storage 130 in the embodiment. As mentioned above, in the embodiment, as viewing information which is transmitted from the television 100 for receiving the digital broadcasting to the mobile information terminal 120, the keywords extracted from the program information obtained in the information processing unit 107 and the program name are used. Therefore, in a database 321 which is constructed in the viewing information storing unit in the storage 130, as shown in FIG. 3, the viewing information constructed by the program name and the associated keywords is stored in such a format that they are piled in viewing order (date and time order).

In the example of FIG. 3, although the number of keywords associated with one program is equal to 4, it is merely an example and the number of keywords which can be stored can be properly set in accordance with a system construction of the mobile information terminal 120. That is, if the number of keywords is set to a small value, a capacity of a memory which is necessary can be reduced. On the contrary, if the number of keywords is set to a large value, in a favorite presuming process regarding the program viewing, which will be described hereinafter, the more preferable favorite can be presumed.

Subsequently, the operation at the time of executing a program recommending process according to the favorite of the user who possesses the mobile information terminal 120 by using the database constructed in the viewing information storing unit in the storage 130 of the mobile information terminal 120 will be described.

In the case where the user who possesses the mobile information terminal 120 requests the television 100 for receiving the digital broadcasting to display the recommended programs by the operation of a remote control or the like during the viewing of the television 100 for receiving the digital broadcasting, first, the CPU 101 requests the mobile information terminal 120 to transmit the storage viewing information for program recommendation through the transmission and reception processing unit 112 on the side of the television for receiving the digital broadcasting. In response to instructions of the CPU 121, the mobile information terminal 120 which received the request from the television 100 for receiving the digital broadcasting transmits the viewing information stored in the viewing information storing unit in the storage 130, that is, in the case of the embodiment, the whole contents in the database 321 shown in FIG. 3, as storage viewing information for program recommendation, to the television 100 for receiving the digital broadcasting through the transmission and reception processing unit 152 of the mobile information terminal 120.

The storage viewing information for program recommendation which was transmitted from the mobile information terminal 120 and received by the transmission and reception processing unit 112 on the side of the television for receiving the digital broadcasting is inputted to the favorite presuming unit 109, by which a presuming process of the favorite regarding the program viewing of the user who possesses the mobile information terminal 120 is executed. In the embodiment, the number of appearance times of the storage viewing information for program recommendation which was transmitted from the mobile information terminal 120 (that is, the whole contents in the database 321 shown in FIG. 3) is summed every keyword, thereby regarding the obtained sum as a favorite presumption result.

For example, in the case where a keyword of “baseball” appeared 7 times, a keyword of “hot spring” appeared 6 times, a keyword of “nagano” appeared 4 times, a keyword of “gourmet” appeared 3 times, and a keyword of “reasoning” appeared 2 times in the storage viewing information for program recommendation which was received by the television 100 for receiving the digital broadcasting, by converting the number of appearance times into points in such a manner that the keyword “baseball” is 7 points, the keyword “hot spring” is 6 points, the keyword “nagano” is 4 points, the keyword “gourmet” is 3 points, and the keyword “reasoning” is 2 points, respectively, it is presumed that there is such a tendency that the owner of the mobile information terminal 120 likes the programs regarding the keywords of “baseball” and “hot spring” whose points are large.

In the digital broadcasting, generally, as associated information data, besides the program information of the program which is on air at present, program information of programs which are scheduled to be broadcasted until about one week ahead in each channel is included. To a group of program information of the programs which are scheduled to be broadcasted until about one week ahead, the CPU 101 searches it by using the favorite presumption result (a group of keywords of the larger points) presumed by the favorite presuming unit 109. By this process, for example, in the foregoing example, the program information having the keywords such as “baseball” and “hot spring” is extracted. That is, the extracted program information is program information of the programs to be recommended. The CPU 101 outputs the program information of the recommended programs extracted from the program information obtained in the information processing unit 107 to the display processing unit 108. In the display processing unit 108, a superimposing process into the program video image which is on air, an exchanging process from the program video image which is on air, or the like is executed and the resultant video image is displayed to the display device 110. As a displaying method, for example, a mark indicative of the recommended program may be added to the corresponding program in an electronic program table or a dedicated display screen for the recommended programs in which only the recommended programs are listed up may be prepared. Thus, by the display device 110, the user who possesses the mobile information terminal 120 can confirm a processing result responsive to a displaying request of the recommended programs which was performed by the user himself. The favorite presuming unit 109 and the CPU 101 may be constructed as an integrated recommended program selecting unit.

As described above, by applying the program recommending apparatus and the information terminal apparatus or the program recommending system of the invention as shown in the embodiment, the user of the television 100 for receiving the digital broadcasting can obtain the program recommendation result which is most preferable to the user himself on the basis of the past program viewing history stored in the mobile information terminal 120 possessed by the user himself without being influenced by the past viewing histories of other users. Since the program recommending process is executed by using the past program viewing history stored in the mobile information terminal side, even if the user who possesses another mobile information terminal which differs from the foregoing mobile information terminal 120 and to which the information terminal apparatus of the invention has been applied uses the television 100 for receiving the digital broadcasting, the program recommendation result which is preferable to the user who possesses such another mobile information terminal mentioned above can be obtained.

As shown in the example of FIG. 2, in the case where a plurality of users who view the television 100 for receiving the digital broadcasting exist simultaneously and the mobile information terminal of each user is in a state where the storage viewing information for program recommendation can be transmitted, the favorite presuming process regarding the program viewing may be executed by using only the storage viewing information for program recommendation obtained from any one of the mobile information terminals possessed by the plurality of users. The user may dare to execute the favorite presuming process regarding the program viewing by using the sum of the storage viewing information for program recommendation obtained from the mobile information terminals possessed by the plurality of users.

For example, as shown in FIG. 2, an explanation will be made with respect to the case where there are three users who simultaneously view the television 100 for receiving the digital broadcasting and the favorite presuming process regarding the program viewing is executed by using only the storage viewing information for program recommendation obtained from one of the mobile information terminals 120a, 120b, and 120c possessed by the three users. When one of the three users requests the television 100 for receiving the digital broadcasting to display the recommended programs by the operation of the remote control or the like, by an OSD displaying function or the like which the television 100 for receiving the digital broadcasting has, the user is allowed to select either a mode in which the favorite presumption regarding the program viewing is performed on the basis of the viewing information stored in the viewing information storing unit of one of the mobile information terminals 120a, 120b, and 120c or a mode in which the favorite presumption regarding the program viewing is performed on the basis of the storage viewing information for program recommendation transmitted from one of the mobile information terminals 120a, 120b, and 120c. By this process, the preferable program recommendation result can be obtained on the basis of the past program viewing history (stored in the selected mobile information terminal) of the user who possesses the selected mobile information terminal. In this case, the program recommendation result which is obtained is not influenced by the past viewing histories stored in the non-selected mobile information terminals.

Subsequently, an example of another operation in the favorite presuming unit 109 of the television 100 for receiving the digital broadcasting will be described with reference to FIG. 4. In the example of FIG. 4, the favorite presuming process regarding the program viewing is executed on the basis of the sum of the storage viewing information for program recommendation obtained from the mobile information terminals possessed by the plurality of users.

For example, as shown in FIG. 2, it is assumed that there are three users who simultaneously view the television 100 for receiving the digital broadcasting and the three users possess the mobile information terminals 120a, 120b, and 120c, respectively. The television 100 for receiving the digital broadcasting which received the storage viewing information for program recommendation from each terminal inputs each of the storage viewing information for program recommendation received by the transmission and reception processing unit 112 on the side of the television for receiving the digital broadcasting to the favorite presuming unit 109 by the control of the CPU 101. Subsequently, in the favorite presuming unit 109, the number of appearance times of the keywords is collected and converted into the points every storage viewing information for program recommendation transmitted from each of the mobile information terminals 120a, 120b, and 120c, and a collection result is obtained.

Results obtained by collecting the number of appearance times of the keywords of the storage viewing information for program recommendation transmitted from each of the mobile information terminals 120a, 120b, and 120c, and converting into the points are shown in collection results 409a, 409b, and 409c in FIG. 4. At this time, the favorite presuming unit 109 further obtains a total collection result 409d serving as a result of the summing from the collection results 409a, 409b, and 409c. The total collection result 409d is set to a favorite presumption result as a sum of the favorites of the three users. By using the total collection result 409d, the CPU 101 searches the program information group obtained in the information processing unit 107, that is, the program information group of the programs which are scheduled to be broadcasted until about one week ahead. The program information extracted by the searching process is displayed to the display device 110 as program information of the programs to be recommended. Thus, the preferable program recommendation result can be obtained in common to the three users who simultaneously view the television 100 for receiving the digital broadcasting.

In the foregoing calculating process of the total collection result as a sum of the favorites of the three users which is executed in the favorite presuming unit 109, naturally, it is also possible to construct in such a manner that the collection of the number of appearance times of the keywords and the conversion into the points are executed in a lump from the storage viewing information for program recommendation transmitted from each of the mobile information terminals 120a, 120b, and 120c, and the total collection result 409d is directly calculated without obtaining the states of the individual collection results 409a, 409b, and 409c.

In the mobile information terminals and the program recommending system to which the information terminal apparatus of the invention has been applied, an application program which uses the mobile information terminal as a remote control of the television for receiving the digital broadcasting may be stored into the ROM 123, storage 130, or the like of the mobile information terminal. The application program may be stored at the time of manufacturing of the mobile information terminal 120 or may be obtained from an external apparatus through the telephone network communicating unit 151 or the LAN communicating unit 152.

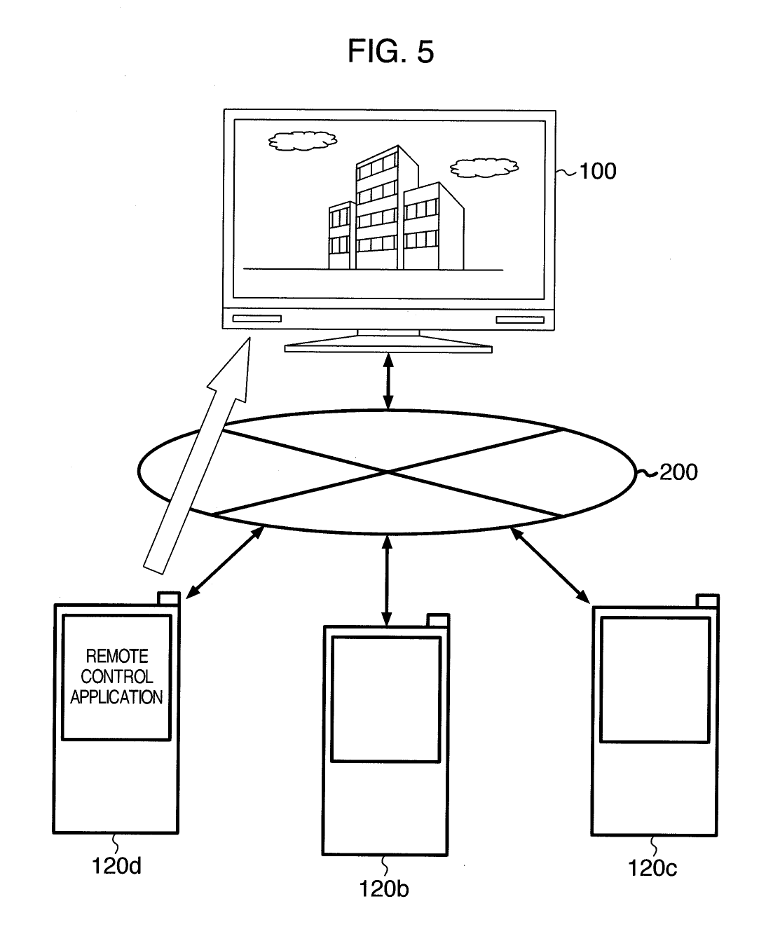

FIG. 5 shows mobile information terminals 120b, 120c, and 120d connected to the television 100 for receiving the digital broadcasting through the network 200. An example in the case where the user who possesses the mobile information terminal 120d uses the mobile information terminal 120d as a remote control of the television 100 for receiving the digital broadcasting by an addition of an application and mainly operates/views the television 100 for receiving the digital broadcasting will now be described with reference to FIG. 5.

In the example shown in FIG. 5, for instance, a case where the user who possesses the mobile information terminal 120d uses the mobile information terminal 120d as a remote control of the television 100 for receiving the digital broadcasting and requests the television 100 for receiving the digital broadcasting to display the recommended programs will be described. In order to use the terminal as a remote control, for example, it is sufficient to construct in such a manner that, by using the installed application, an electronic program table or the like is displayed onto the display device of the mobile information terminal 120d and instruction information to instruct the viewing of the program selected from the table is formed and transmitted to the television for receiving the digital broadcasting. It is sufficient to store such an application into the storage or ROM of the mobile information terminal 120d. As a method of storing the application into the storage or ROM, the application may be previously stored upon shipping of the mobile information terminal. On the other hand, an application program may be downloaded from a server on the network connected through the telephone network communicating unit, the LAN communicating unit, or the like of the mobile information terminal 120d and stored into the storage or ROM.

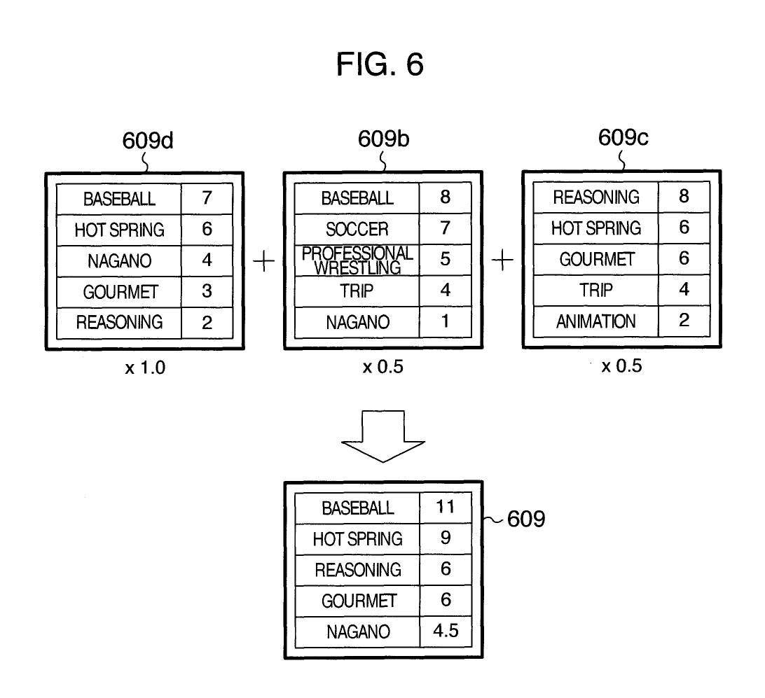

In the process for calculating the total collection result indicative of the sum of the favorites of the three users which is executed in the favorite presuming unit 109, a process shown in FIG. 6 may be executed. In FIG. 6, when a collection result 609d obtained by executing the keyword collection and point conversion from the storage viewing information for program recommendation transmitted from the mobile information terminal 120d and collection results 609b and 609c obtained by executing the keyword collection and point conversion from the storage viewing information for program recommendation transmitted from the mobile information terminals 120b and 120c are added, a difference is caused in weights by multiplying a different coefficient or the like. As shown in FIG. 6, when the collection results are added, the collection result 609d based on the storage viewing information for program recommendation transmitted from the mobile information terminal 120d possessed by the user who mainly operates/views the television 100 for receiving the digital broadcasting is multiplied by a coefficient “1.0”, the collection results 609b and 609c based on the storage viewing information for program recommendation transmitted from the mobile information terminals 120b and 120c possessed by the users who passively operate/view the television 100 for receiving the digital broadcasting are multiplied by a coefficient “0.5”, and the sum is calculated. The program information group obtained in the information processing unit 107, that is, the program information group of the programs which are scheduled to be broadcasted until about one week ahead is searched by using a total collection result 609 obtained by the above process, so that a program recommendation in which the information of the programs to be recommended in common to the three users who possess the mobile information terminals 120b, 120c, and 120d, that is, the favorite of the user who possesses the mobile information terminal 120d and mainly operates/views the television 100 for receiving the digital broadcasting is slightly preferentially used can be performed.

In the foregoing example, the description has been made on the assumption that, in the television 100 for receiving the digital broadcasting, the process for transmitting the viewing information to the mobile information terminal 120 and the process for receiving the storage viewing information for program recommendation transmitted from the mobile information terminal 120 are executed in a lump in the transmission and reception processing unit 112 on the side of the television for receiving the digital broadcasting. However, the transmission processing unit on the side of the television for receiving the digital broadcasting and the reception processing unit on the side of the television for receiving the digital broadcasting may be separately prepared. In this case, it is sufficient that the process for transmitting the viewing information to the mobile information terminal 120 is executed in the transmission processing unit on the side of the television for receiving the digital broadcasting and the process for receiving the storage viewing information for program recommendation transmitted from the mobile information terminal 120 is executed in the reception processing unit on the side of the television for receiving the digital broadcasting.

Similarly, in the foregoing example, the description has been made on the assumption that, in the mobile information terminal 120, the process for receiving the viewing information transmitted from the television 100 for receiving the digital broadcasting and the process for transmitting the storage viewing information for program recommendation to the television 100 for receiving the digital broadcasting are executed in a lump in the transmission and reception processing unit 152 on the mobile information terminal side. Also with respect to this example, the reception processing unit on the mobile information terminal side and the transmission processing unit on the mobile information terminal side may be separately prepared. In this case, it is sufficient that the process for receiving the viewing information transmitted from the television 100 for receiving the digital broadcasting is executed in the reception processing unit on the mobile information terminal side and the process for transmitting the storage viewing information for program recommendation to the television 100 for receiving the digital broadcasting is executed in the transmission processing unit on the mobile information terminal side.

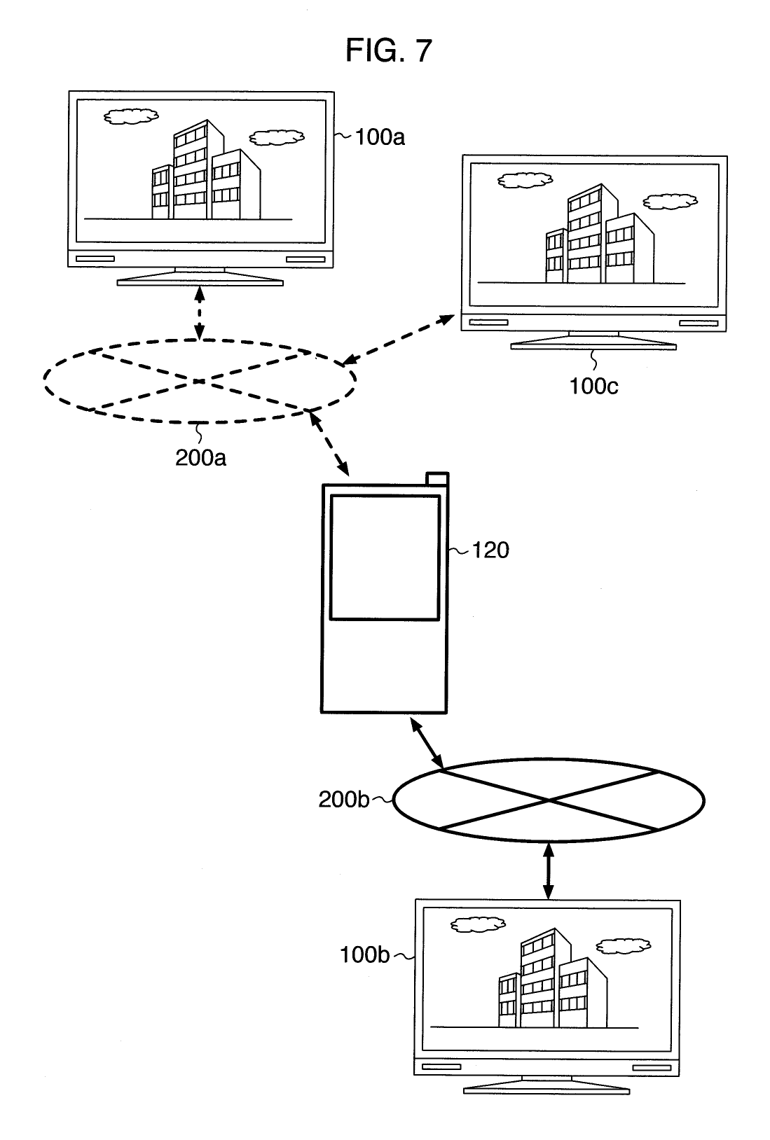

Subsequently, another example in the case where the program recommending apparatus and the information terminal apparatus of the invention are applied to the television for receiving the digital broadcasting and the mobile information terminal, thereby constructing the program recommending system will be described with reference to FIG. 7.

In the example of FIG. 7, it is assumed that the user who possesses the mobile information terminal 120 uses a television 100a for receiving the digital broadcasting connected through a network 200a in the ordinary state. In this case, a past viewing history obtained by repeating the viewing of the television 100a for receiving the digital broadcasting has been constructed as a database in the viewing information storing unit in the storage 130 of the mobile information terminal 120. In the case where the user who possesses the mobile information terminal 120 requests the television 100a for receiving the digital broadcasting to display the recommended programs, as described in the foregoing example, the television 100a for receiving the digital broadcasting presumes the favorite regarding the program viewing of the user who possesses the mobile information terminal 120 from the storage viewing information for program recommendation received from the mobile information terminal 120 and can display the program information of the programs to be recommended.

In the case where, for example, the user who possesses the mobile information terminal 120 moves and uses a television 100b for receiving the digital broadcasting at a place of the movement destination, he carries the mobile information terminal 120 to the movement destination and connects it to the television 100b for receiving the digital broadcasting through a network 200b. Therefore, in a manner similar to the case of using the television 100a for receiving the digital broadcasting, the program recommendation information which is preferable to the user who possesses the mobile information terminal 120 can be displayed to the television 100b for receiving the digital broadcasting. That is, in the apparatus and system of the invention, the database of the past viewing histories of the user who possesses the mobile information terminal 120 has been stored in the mobile information terminal 120 instead of the television 100a for receiving the digital broadcasting which is ordinarily used. Therefore, even if the television for receiving the digital broadcasting which is used was changed from the television 100a for receiving the digital broadcasting to the television 100b for receiving the digital broadcasting, the favorite regarding the program viewing of the user who possesses the mobile information terminal 120 can be presumed on the basis of the storage viewing information for program recommendation received from the mobile information terminal 120 by the television 100b for receiving the digital broadcasting, so that the program information of the more preferable programs to be recommended can be extracted even at the movement destination. For example, when the user who possesses the mobile information terminal 120 has made a trip or the like, if a television for receiving the digital broadcasting at a trip destination is the program recommending apparatus according to the invention or the like, the user can obtain the more preferable recommended program information even at the trip destination.

Similarly, for example, even in the case where the user bought a television 100c for receiving the digital broadcasting in place of the television 100a for receiving the digital broadcasting, or the like, since the past viewing history of the user exists in the mobile information terminal 120, just after the television for receiving the digital broadcasting was changed from the television 100a for receiving the digital broadcasting to the television 100c for receiving the digital broadcasting, the program information of the programs which should be recommended and are preferable to the user who possesses the mobile information terminal 120 can be extracted.

According to the embodiment 1 of the invention described above, the more preferable program recommendation can be performed.

### Embodiment 2

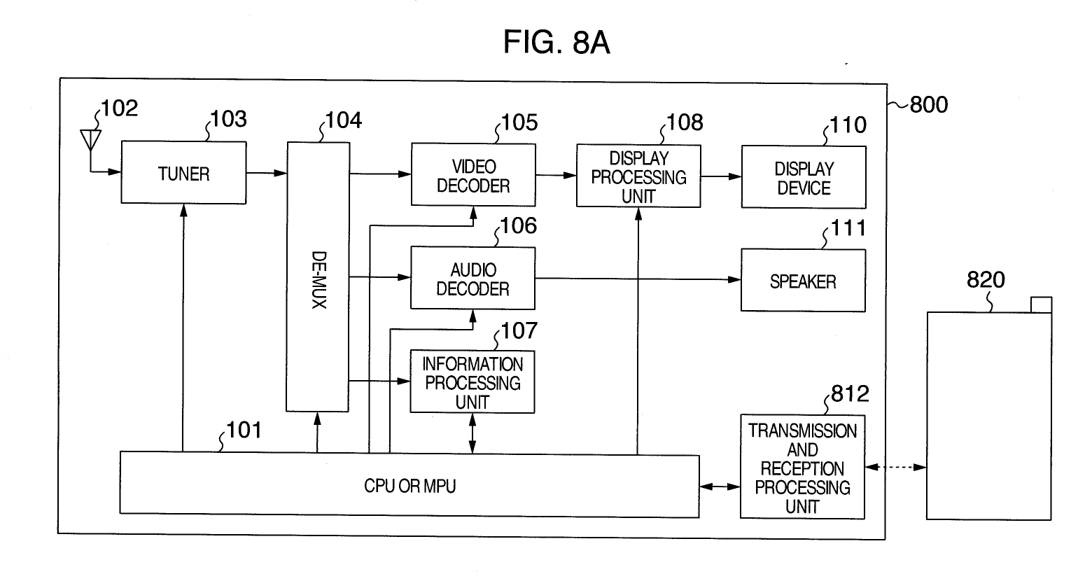

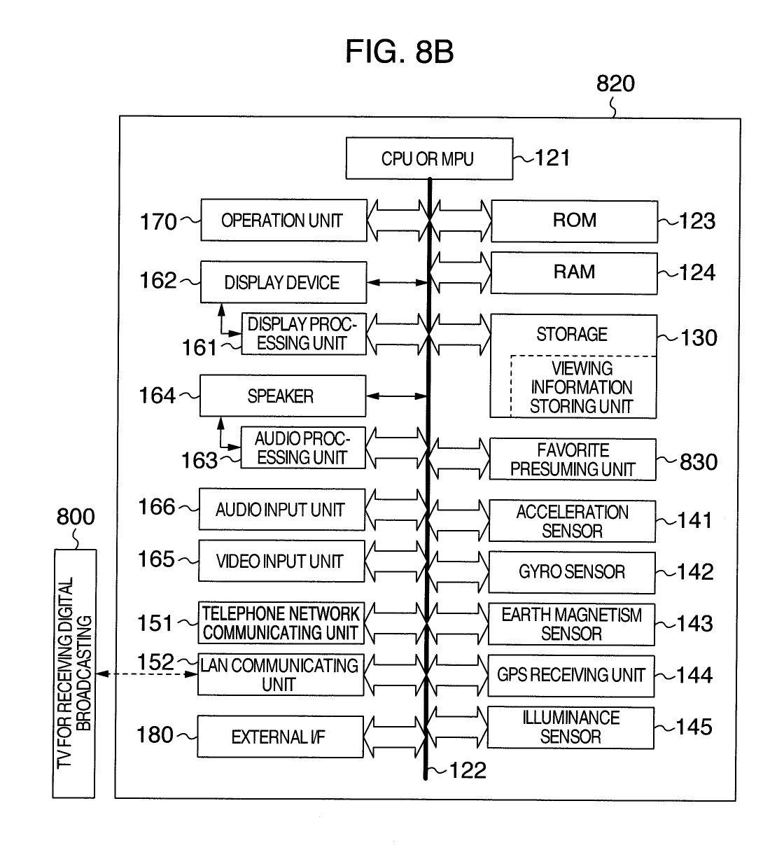

Subsequently, a program recommending system including a program recommending apparatus (800) and an information terminal apparatus (820) according to the embodiment 2 of the invention will be described with reference to FIGS. 8A and 8B. In an example of FIGS. 8A and 8B, the program recommending apparatus is constructed as a television for receiving the digital broadcasting. It is assumed that in the diagrams, portions having the same reference numerals as those in the embodiment 1 have/execute the same construction/operation as those in the embodiment 1 and their description is omitted here. Reference numeral 812 denotes a transmission and reception processing unit on the side of the television for receiving the digital broadcasting and 830 indicates a favorite presuming unit.

Also in the embodiment, processes at the time of the ordinary viewing operation are similar to those in the embodiment 1. That is, the CPU 101 transmits the program information obtained by the information processing unit 107 as viewing information to the mobile information terminal 820 through the transmission and reception processing unit 812 on the side of the television for receiving the digital broadcasting. On the mobile information terminal 820 side, on the basis of the control of the CPU 121, the viewing information transmitted from the television 800 for receiving the digital broadcasting is received by the transmission and reception processing unit 152 on the mobile information terminal side and properly stored into the viewing information storing unit in the storage 130. Since it is sufficient that a construction of the viewing information which is transmitted from the television 800 for receiving the digital broadcasting to the mobile information terminal 820 and a database which is constructed in the viewing information storing unit in the storage 130 are also similar to those in the embodiment 1, their description is omitted here.

In this instance, the operation at the time of executing the program recommending process according to the favorite of the user who possesses the mobile information terminal 820 by using the database constructed in the viewing information storing unit in the storage 130 of the mobile information terminal 820 differs from that in the embodiment 1. The relevant operation will be described hereinbelow.

In the case where the user who possesses the mobile information terminal 820 requests the television 800 for receiving the digital broadcasting to display the recommended programs by the operation of the remote control or the like during the viewing of the television 800 for receiving the digital broadcasting, the CPU 101 requests the mobile information terminal 820 to transmit the program recommendation information through the transmission and reception processing unit 812 on the side of the television for receiving the digital broadcasting. In response to instructions of the CPU 121, the mobile information terminal 820 which received the request from the television 800 for receiving the digital broadcasting reads out the viewing information stored in the viewing information storing unit in the storage 130, that is, the whole contents in the database 321 shown in FIG. 3 and inputs to the favorite presuming unit 830. In the favorite presuming unit 830, a collection result in which the number of appearance times has been collected every keyword from the inputted whole contents in the database and, further, converted into the points is calculated. Further, the CPU 121 of the mobile information terminal 820 transmits the collection result calculated in the favorite presuming unit 830 as program recommendation information to the television 800 for receiving the digital broadcasting through the transmission and reception processing unit 152 on the mobile information terminal side.

On the basis of the program recommendation information which was transmitted from the mobile information terminal 820 and received by the transmission and reception processing unit 812 on the side of the television for receiving the digital broadcasting, the CPU 101 searches the program information group obtained in the information processing unit 107, that is, the program information group of the programs which are scheduled to be broadcasted until about one week ahead, so that the program information of the programs to be recommended is extracted. The program information of the programs to be recommended is outputted to the display processing unit 108. At this time, in the display processing unit 108, a superimposing process into the program video image which is on air, an exchanging process from the program video image which is on air, or the like is executed and the resultant video image is displayed to the display device 110. Thus, by the display device 110, the user who possesses the mobile information terminal 820 can confirm a processing result responsive to a displaying request of the recommended programs which was performed by the user himself.

As described above, in the program recommending apparatus and the information terminal apparatus or the program recommending system according to the embodiment 2 of the invention, the favorite presuming process is executed on the mobile information terminal 820 side. An effect similar to that in the case of the embodiment 1 can be obtained even by such a construction. In the case of the construction of the embodiment 2, the program recommendation information which is transmitted from the mobile information terminal 820 to the television 800 for receiving the digital broadcasting is a result obtained by collecting the viewing information stored in the viewing information storing unit in the storage 130. Therefore, as compared with the storage viewing information for program recommendation which is transmitted from the mobile information terminal 120 to the television 100 for receiving the digital broadcasting in the embodiment 1, it can be expected that an amount of data which is transmitted is reduced.

Also in the construction of the embodiment 2, even in the case where the television for receiving the digital broadcasting which is used was changed, the program information which is suitable for the user of the mobile information terminal can be provided. The transmission and reception processing unit 812 on the side of the television for receiving the digital broadcasting even in the television 800 for receiving the digital broadcasting may be replaced by the transmission processing unit on the side of the television for receiving the digital broadcasting and the reception processing unit on the side of the television for receiving the digital broadcasting. The transmission and reception processing unit 152 on the side of the mobile information terminal in the mobile information terminal 820 may be replaced by the reception processing unit on the mobile information terminal side and the transmission processing unit on the mobile information terminal side.

According to the embodiment 2 of the invention described above, the more preferable program recommendation can be performed. As compared with the embodiment 1, an amount of information which is transmitted between the television for receiving the digital broadcasting and the mobile information terminal can be reduced.

### Embodiment 3

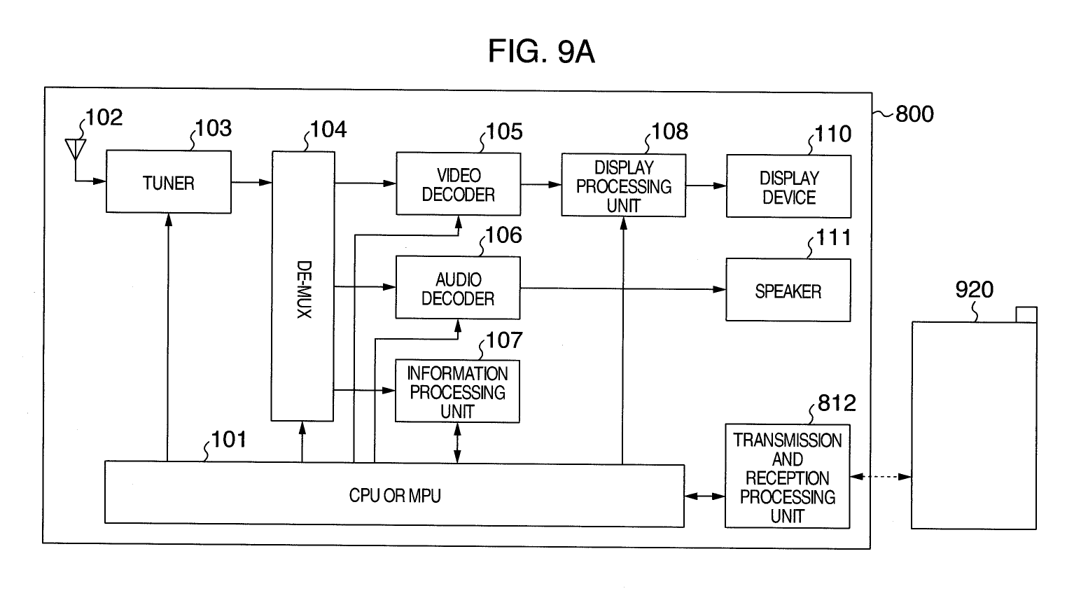

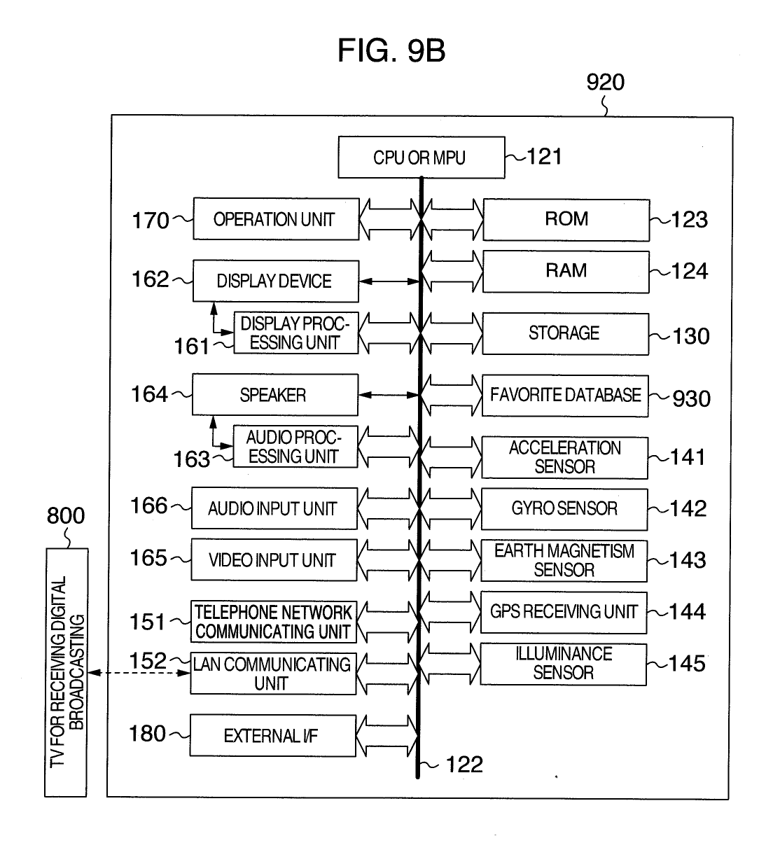

FIGS. 9A and 9B show an example in which the mobile information terminal 820 in the embodiment 2 described by using FIGS. 8A and 8B has been replaced by another mobile information terminal (920) having a different construction. It is assumed that in the diagrams, portions having the same reference numerals as those in the embodiment 1 or 2 have/execute the same construction/operation as those in the embodiment 1 or 2 and their description is omitted here. Reference numeral 930 denotes a favorite database.

In the embodiment, at the time of the ordinary viewing operation, the CPU 101 transmits the program information obtained by the information processing unit 107 as viewing information to the mobile information terminal 920 through the transmission and reception processing unit 812 on the side of the television for receiving the digital broadcasting. On the mobile information terminal 920 side, on the basis of the control of the CPU 121, the viewing information transmitted from the television 800 for receiving the digital broadcasting is received by the transmission and reception processing unit 152 on the mobile information terminal side and properly stored into the favorite database 930. However, in the apparatus/system of the embodiment, when the viewing information received by the transmission and reception processing unit 152 on the mobile information terminal side is written into the favorite database 930, such an operation that the viewing information is stored into the viewing information storing unit in the storage 130 in the format of the database 321 shown in FIG. 3 like the apparatus/system of the embodiment is not executed but the keywords included in the viewing information received by the transmission and reception processing unit 152 on the mobile information terminal side are stored in the format of the collection results shown in FIG. 4 or 6 together with a keyword group which has already been stored in the favorite database 930 while executing the collection of the number of appearance times of the keywords and the point conversion thereof. That is, the favorite database 930 in the apparatus/system of the embodiment is a portion having both of the function of the viewing information storing unit in the storage 130 in the apparatus/system of the embodiment 2 shown in FIGS. 8A and 8B and the function of the favorite presuming unit 830.

The operation at the time of executing the program recommending process according to the favorite of the user who possesses the mobile information terminal 920 by using the favorite collection result constructed in the favorite database 930 of the mobile information terminal 920 is executed as follows in the embodiment.

In the case where the user who possesses the mobile information terminal 920 requests the television 800 for receiving the digital broadcasting to display the recommended programs by the operation of the remote control or the like during the viewing of the television 800 for receiving the digital broadcasting, the CPU 101 requests the mobile information terminal 920 to transmit the favorite collection result through the transmission and reception processing unit 812 on the side of the television for receiving the digital broadcasting. In response to instructions of the CPU 121, the mobile information terminal 920 which received the request from the television 800 for receiving the digital broadcasting transmits the favorite collection result stored in the favorite database 930 to the television 800 for receiving the digital broadcasting through the transmission and reception processing unit 152 on the mobile information terminal side.

On the basis of the favorite collection result which was transmitted from the mobile information terminal 920 and received by the transmission and reception processing unit 812 on the side of the television for receiving the digital broadcasting, the CPU 101 searches the program information group obtained in the information processing unit 107, that is, the program information group of the programs which are scheduled to be broadcasted until about one week ahead, so that the program information of the programs to be recommended is extracted. The program information of the programs to be recommended is outputted to the display processing unit 108. In the display processing unit 108, a superimposing process into the program video image which is on air, an exchanging process from the program video image which is on air, or the like is executed and the resultant video image is displayed to the display device 110. Thus, by the display device 110, the user who possesses the mobile information terminal 920 can confirm a processing result responsive to a displaying request of the recommended programs which was performed by the user himself.

Also in the construction of the embodiment 3 described above, even in the case where the television for receiving the digital broadcasting which is used was changed, the program information which is suitable for the user of the mobile information terminal can be provided. In the case of the construction of the embodiment, it can be expected that a capacity of a memory constructing the favorite database 930 can be reduced as compared with the capacity of the memory constructing the viewing information storing unit in the storage 130.

Also in the construction of the embodiment, even in the case where a plurality of mobile information terminals exist on the same network or even in the case where the television for receiving the digital broadcasting which is used was changed, the program information which is suitable for the user of the mobile information terminal can be provided. The transmission and reception processing unit 152 on the mobile information terminal side in the mobile information terminal 920 may be replaced by the reception processing unit on the mobile information terminal side and the transmission processing unit on the mobile information terminal side.

According to the embodiment 3 of the invention described above, the more preferable program recommendation can be performed. As compared with the embodiment 1 or 2, a capacity of the memory for storing the favorite database can be reduced.

### Embodiment 4

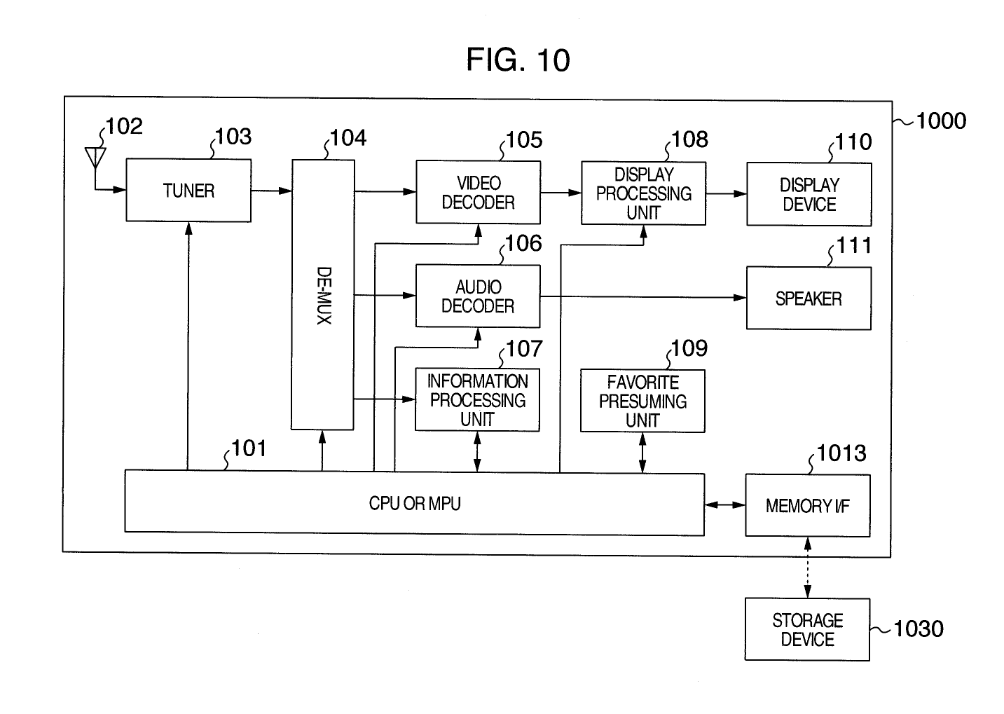

FIG. 10 shows the embodiment 4 of the invention. A construction of the embodiment is not an example in which the system is constructed together with the mobile information terminal and network to which the information terminal apparatus of the invention has been applied and the network but is an example of a construction in which an effect similar to that of the construction of each of the foregoing embodiments can be obtained only by a television 1000 for receiving the digital broadcasting to which the program recommending apparatus of the invention has been applied.

It is assumed that in FIG. 10, portions having the same reference numerals as those in each of the foregoing embodiments have/execute the same construction/operation as those in each of the foregoing embodiments and their description is omitted here. Reference numeral 1013 denotes a memory interface and 1030 indicates a storage device such as a flash memory. The storage device 1030 is a removable storage device which is managed by the user and is detachable to/from the memory interface 1013 of the television 1000 for receiving the digital broadcasting. When the user uses the television 1000 for receiving the digital broadcasting, he loads the storage device 1030 which is managed by the user himself into the memory interface 1013 of the television 1000 for receiving the digital broadcasting.

In the ordinary viewing operation, when the user performs a tuning instruction by operating the remote control or the like, the CPU 101 controls the tuner 103 so as to extract a signal of a desired channel. On the basis of the control of the CPU 101, the information processing unit 107 obtains program information including a program name, a genre, a name of the performer, and the like from the associated information data of the selected channel. Further, the CPU 101 executes a process for properly storing the program information obtained in the information processing unit 107 as viewing information into the storage device 1030 through the memory interface 1013. Also in the embodiment, it is assumed that the viewing information which is stored into the storage device 1030 includes the keywords and program name extracted by the CPU 101 from the program information obtained in the information processing unit 107 and is stored into the storage device 1030 in the format of the database 321 shown in FIG. 3.

Subsequently, the operation at the time when the program recommending process according to the favorite of the user who manages the storage device 1030 is executed by using the database constructed in the storage device 1030 will be described hereinbelow.

In the case where the user who manages the storage device 1030 requests the television 1000 for receiving the digital broadcasting to display the recommended programs by the operation of the remote control or the like during the viewing of the television 1000 for receiving the digital broadcasting, the CPU 101 reads out the whole contents in the database from the storage device 1030 through the memory interface 1013 and inputs to the favorite presuming unit 109. After that, since the presuming process of the favorite regarding the program viewing of the user in the favorite presuming unit, the searching process using the favorite presumption result to the program information group obtained in the information processing unit 107, that is, the program information group of the programs which are scheduled to be broadcasted until about one week ahead, the displaying process of the program information of the programs to be recommended in the display processing unit 108 and the display device 110, and the like are similar to those in the embodiment 1, their description is omitted here.

As described above, according to the embodiment 4 of the invention, the user of the television 1000 for receiving the digital broadcasting can obtain the program recommendation result more preferably to himself on the basis of his own past program viewing history stored in the storage device 1030 which is managed by the user himself without being influenced by the past program viewing histories of other persons. In the construction of the embodiment, the mobile information terminal is unnecessary, the construction of the system by the connection through the network is also unnecessary, and the information of the recommended programs can be more easily obtained.

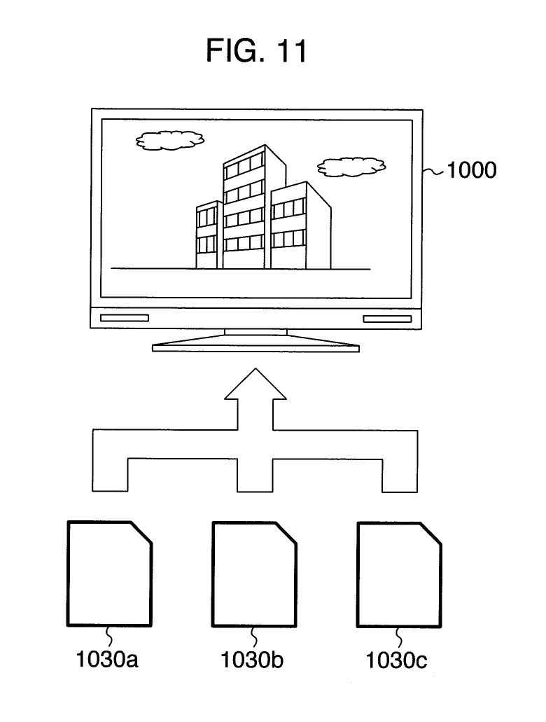

For example, as shown in FIG. 11, in the case where three users who simultaneously view the television 1000 for receiving the digital broadcasting exist and they manage storage devices 1030a, 1030b, and 1030c which store the databases of their own past viewing histories, respectively, if the storage device 1030a is connected to the memory interface 1013 of the television 1000 for receiving the digital broadcasting, the favorite presuming process regarding the program viewing is executed on the basis of the past viewing history (recorded in the storage device 1030a) of the user who manages the storage device 1030a. If the storage device 1030b is connected to the memory interface 1013 of the television 1000 for receiving the digital broadcasting, the favorite presuming process regarding the program viewing is executed on the basis of the past viewing history (recorded in the storage device 1030b) of the user who manages the storage device 1030b.

Also in the case where the user carries the storage device which is managed by himself and views a television for receiving the digital broadcasting different from the television for receiving the digital broadcasting which is ordinarily used, by connecting the carried storage device to a memory interface of the different television for receiving the digital broadcasting, the preferable program recommendation result based on his own past viewing history can be obtained.

According to the embodiment 4 of the invention described above, the more preferable program recommendation can be performed. It can be realized by a simpler construction as compared with the constructions of the embodiments 1 to 3.

### Embodiment 5

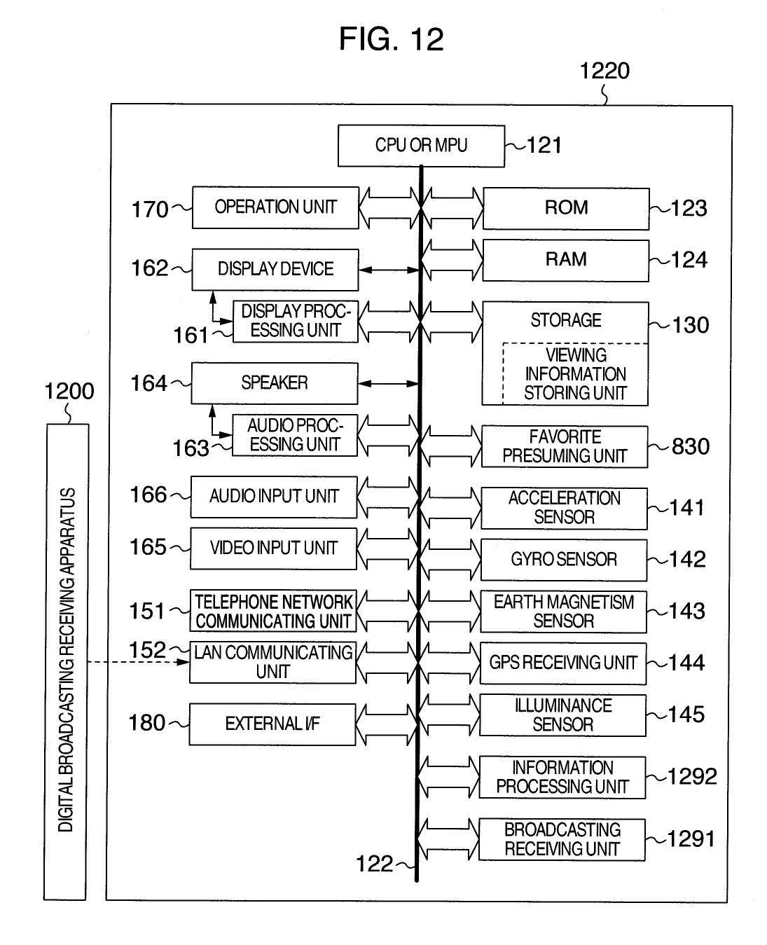

FIG. 12 shows the embodiment 5 of the invention. A mobile information terminal 1220 in a construction of the embodiment constructs an apparatus in which the program information extracted on the basis of a past viewing history of the owner of the mobile information terminal 1220, that is, the program information of the programs to be recommended can be confirmed by the mobile information terminal 1220. In the diagram, reference numeral 1291 denotes a broadcasting receiving unit; 1292 an information processing unit; and 1200 a broadcasting receiving apparatus. It is assumed that other portions having the same reference numerals as those in each of the foregoing embodiments have/execute the same. construction/operation as those in each of the embodiments and their description is omitted here.

At the time of the ordinary viewing operation, the operations which are executed until the user performs a tuning instruction by operating the remote control or the like to the broadcasting receiving apparatus 1200 (having a construction similar to that of the program recommending apparatus in the foregoing embodiment) which can transmit the viewing information to the mobile information terminal 1220 and the broadcasting receiving apparatus 1200 transmits the viewing information to the mobile information terminal 1220 are executed in a manner similar to the embodiment 2. On the basis of the control of the CPU 121, in the mobile information terminal 1220, the viewing information transmitted from the broadcasting receiving apparatus 1200 is received by the reception processing unit 152 on the mobile information terminal side and is properly stored into the viewing information storing unit in the storage 130. It is now assumed that a construction of the viewing information which is transmitted from the broadcasting receiving apparatus 1200 to the mobile information terminal 1220 and a database which is constructed in the viewing information storing unit in the storage 130 are similar to those in the embodiment 1 or 2.

The operation at the time of executing the program recommending process according to the favorite of the user who possesses the mobile information terminal 1220 by using the database constructed in the viewing information storing unit in the storage 130 of the mobile information terminal 1220 is as follows.

In the case where the user who possesses the mobile information terminal 1220 tries to display the recommended programs by operating the mobile information terminal 1220, the CPU 121 of the mobile information terminal 1220 reads out the viewing information (the whole contents in the database) stored in the viewing information storing unit in the storage 130 and inputs to the favorite presuming unit 830. In the favorite presuming unit 830, a collection result in which the number of appearance times has been collected every keyword from the inputted whole contents in the database and, further, converted into the points is calculated in response to instructions of the CPU 121.

The mobile information terminal 1220 has the broadcasting receiving unit 1291 having functions of an antenna, a tuner, a decoder, and the like and can receive the broadcasting wave of the digital broadcasting. The program information group obtained in the information processing unit 1292 from the broadcasting wave of the digital broadcasting received in the broadcasting receiving unit 1291, that is, the program information group of the programs which are scheduled to be broadcasted until about one week ahead is searched by using the collection result obtained in the favorite presuming unit 830. A search result is displayed to the display device 162 on the basis of the control of the CPU 121. Thus, by the display device 162 of the mobile information terminal 1220, the user who possesses the mobile information terminal 1220 can confirm the processing result responsive to the displaying operation of the recommended programs which was performed by the user himself. Although the program information group which is obtained by the information processing unit 1292, that is, the program information group of the programs which are scheduled to be broadcasted until about one week ahead is obtained through the broadcasting receiving unit 1291 in the foregoing example, they may be obtained from the server on the network connected through the LAN communicating unit 152.

The more preferable program recommendation can be performed even by the construction of the embodiment 5 of the invention described above.

In the case of the mobile information terminal 1220 of the construction of the embodiment, a series of processes which are executed until the favorite regarding the program viewing of the user himself is presumed from the viewing information (past viewing history) stored in the viewing information storing unit in the storage 130 and the recommended programs are displayed to the display device 162 can be executed without connecting it to the broadcasting receiving apparatus 1200. That is, even in such a situation that an apparatus which can receive the digital broadcasting does not exist in the circumference, the program information of the program suitable for his own favorite can be confirmed from the program information group of the programs which are scheduled to be broadcasted until about one week ahead.

Also in the construction of the embodiment 5 of the invention, the viewing information storing unit in the storage 130 and the favorite presuming unit 830 can be replaced by the favorite database.

### Embodiment 6

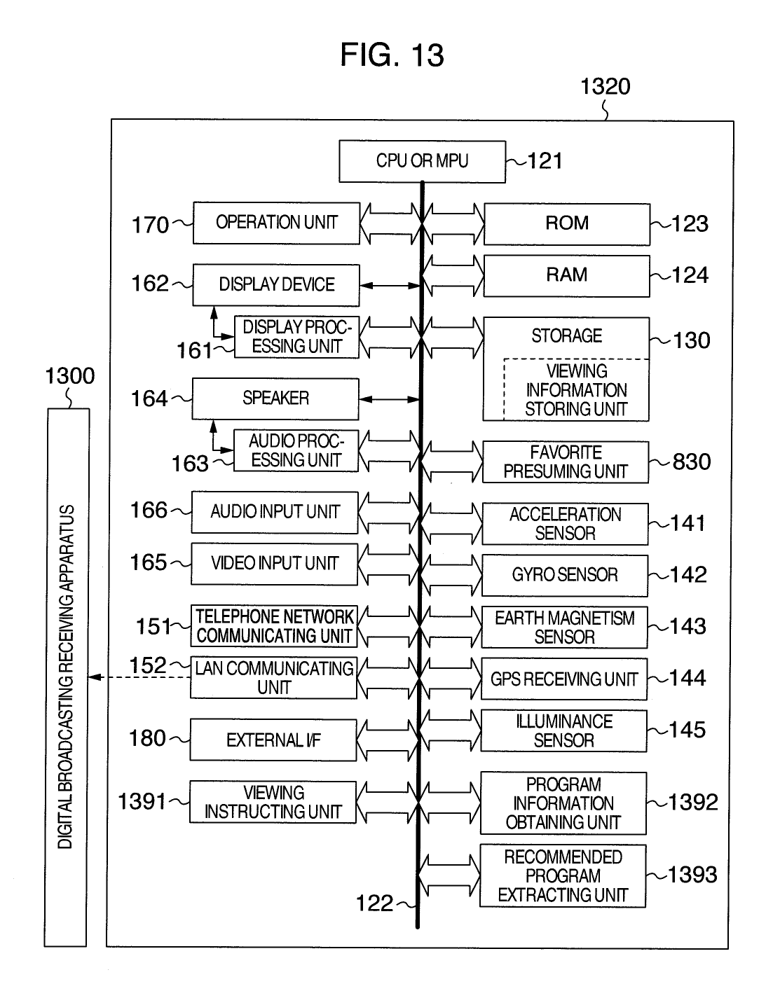

FIG. 13 shows the embodiment 6 of the invention. In a mobile information terminal 1320 of the embodiment, even when it is used in combination with a broadcasting receiving apparatus (1300) serving as a television for receiving the digital broadcasting which does not have the program recommending function and the transmitting function of the viewing information, the program information extracted on the basis of a past viewing history of the owner of the mobile information terminal 1320, that is, the program information of the programs to be recommended can be confirmed by the mobile information terminal 1320.

In the diagram, reference numeral 1391 denotes a viewing instructing unit; 1392 a program information obtaining unit; and 1393 a recommended program extracting unit. It is assumed that other portions having the same reference numerals as those in each of the foregoing embodiments have/execute the same construction/operation as those in each of the embodiments and their description is omitted here.

The mobile information terminal 1320 can be used as a remote control of the television for receiving the digital broadcasting by an installed application. For example, by the application, an electronic program table or the like is displayed onto the display device 162 of the mobile information terminal 1320 and instruction information to instruct the viewing of the program selected from the table is formed and can be transmitted to the television for receiving the digital broadcasting (the broadcasting receiving apparatus 1300 in the embodiment). It is sufficient to store such an application into the storage 130 or ROM 123. A method of storing the application into the storage 130 or ROM 123 may be previously stored at the time of shipping of the mobile information terminal 1320. On the other hand, an application program may be downloaded from the server on the network connected through the telephone network communicating unit 151, the LAN communicating unit 152, or the like and stored into the storage 130 or ROM 123.

At the time of the ordinary viewing, the user who possesses the mobile information terminal 1320 operates/views the broadcasting receiving apparatus 1300 serving as a television for receiving the digital broadcasting by using the remote control function which the mobile information terminal 1320 has. At this time, the following operation is executed in the mobile information terminal 1320.

In response to instructions of the CPU 121, the program information obtaining unit 1392 obtains the program information from the broadcasting wave of the digital broadcasting or via the network such as Internet or the like. The obtained program information is displayed onto the display device 162 through the display processing unit 161 in, for example, the format of an electronic program table. The user who possesses the mobile information terminal 1320 confirms the electronic program table or the like displayed on the display device 162 and selects a program which he wants to view by himself. On the basis of the selection by the user who possesses the mobile information terminal 1320, the viewing instructing unit 1391 makes a viewing instruction to the broadcasting receiving apparatus 1300 serving as a television for receiving the digital broadcasting through the transmission processing unit 152 on the side of the mobile information terminal. The viewing instruction to the broadcasting receiving apparatus 1300 is performed as follows. First, on the basis of the selection by the user who possesses the mobile information terminal 1320, the viewing instructing unit 1391 forms tuning instruction information which can be recognized by the broadcasting receiving apparatus 1300 serving as a television for receiving the digital broadcasting is formed. It is sufficient to output the tuning instruction information from the LAN communicating unit 152 on the mobile information terminal side to the broadcasting receiving apparatus 1300 serving as a television for receiving the digital broadcasting. It is sufficient that the construction of the transmission and reception of the tuning instruction information has a format which can be received by the broadcasting receiving apparatus 1300 and is not limited to the foregoing example. For instance, it is possible to construct in such a manner that an infrared signal transmitting unit is separately provided for the mobile information terminal 1320 and the tuning instruction information is converted into an infrared signal or the like and outputted to the broadcasting receiving apparatus 1300. In the broadcasting receiving apparatus 1300, it is sufficient that the infrared signal is received by an infrared receiving unit or the like for receiving a remote control signal.

The viewing instructing unit 1391 makes the viewing instruction to the broadcasting receiving apparatus 1300. The viewing instructing unit 1391 executes such a process that the program information of the program selected by the user who possesses the mobile information terminal 1320 is stored as viewing information into the viewing information storing unit in the storage 130. As viewing information which is stored into the viewing information storing unit in the storage 130, also in the embodiment, it is assumed that a combination of the keywords extracted from the program information obtained by the program information obtaining unit 1392 and the program name is stored, in a manner similar to the foregoing embodiment 1 or the like.

By executing the foregoing processes at the time of the ordinary viewing, the viewing information history of the user who possesses the mobile information terminal 1320 is stored into the viewing information storing unit in the storage 130. The operation at the time of executing the program recommending process according to the favorite of the user who possesses the mobile information terminal 1320 by using the database constructed in the viewing information storing unit in the storage 130 of the mobile information terminal 1320 is as follows.

In the case where the user who possesses the mobile information terminal 1320 tries to display the recommended programs by operating the mobile information terminal 1320, the CPU 121 of the mobile information terminal 1320 reads out the viewing information (the whole contents in the database) stored in the viewing information storing unit in the storage 130 and inputs to the favorite presuming unit 830. In the favorite presuming unit 830, a collection result in which the number of appearance times has been collected every keyword from the inputted whole contents in the database and, further, converted into the points is calculated in response to instructions of the CPU 121.

In the recommended program extracting unit 1393, by using the collection result obtained in the favorite presuming unit 830, a searching process is executed to the program information group obtained in the program information obtaining unit 1392, that is, the program information group of the programs which are scheduled to be broadcasted until about one week ahead. A search result is displayed to the display device 162 through the display processing unit 161. Thus, by the display device 162 of the mobile information terminal 1320, the user who possesses the mobile information terminal 1320 can confirm the processing result responsive to the displaying operation of the recommended programs which was performed by the user himself. Although the recommended program extracting unit 1393 is shown in FIG. 13 as a portion which is independent on other circuits in the embodiment, it is also possible to construct in such a manner that by using the collection result obtained in the favorite presuming unit 830, the CPU 121 executes the searching process to the program information group obtained in the program information obtaining unit 1392, that is, the program information group of the programs which are scheduled to be broadcasted until about one week ahead, and outputs a search result to the display processing unit 161.

When the recommended programs which were displayed to the display device 162 and selected on the basis of the past viewing history of the user who possesses the mobile information terminal 1320 are viewed, the following process is executed. In a manner similar to the case of the ordinary viewing operation mentioned above, the user who possesses the mobile information terminal 1320 selects the recommended program which he wants to view by himself from a list of the recommended programs displayed onto the display device 162 or the like. On the basis of a recommended program selecting instruction of the user who possesses the mobile information terminal 1320, the viewing instructing unit 1391 makes a viewing instruction to the broadcasting receiving apparatus 1300 serving as a television for receiving the digital broadcasting through the transmission processing unit 152 on the side of the mobile information terminal.

The more preferable program recommendation can be performed even by the construction of the embodiment 6 of the invention described above.

Even by the construction of the embodiment, in the case where the broadcasting receiving apparatus (1300) is changed or the like, the effects which are obtained in the foregoing embodiment 1 or the like can be also similarly obtained.

Further, according to the construction of the embodiment, even in the case of using the apparatus in combination with the broadcasting receiving apparatus (1300) serving as a television for receiving the digital broadcasting which does not have the program recommending function and the transmitting function of the viewing information, the program information which was extracted on the basis of the past viewing history of the owner of the mobile information terminal 1320, that is, the program information of the programs to be recommended can be confirmed by the mobile information terminal 1320. Even in the television for receiving the digital broadcasting which does not have the program recommending function and the transmitting function of the viewing information, the programs which were extracted by the mobile information terminal 1320 and should be recommended can be preferably viewed.

Although the embodiment 6 has been described on the assumption that the broadcasting receiving apparatus 1300 is the television for receiving the digital broadcasting which does not have the program recommending function and the transmitting function of the viewing information, it may be a digital broadcasting recording and reproducing apparatus or the like which does not have the program recommending function. In this case, it is sufficient that in the mobile information terminal 1320, when a recording instruction is performed to the broadcasting receiving apparatus serving as a digital broadcasting recording and reproducing apparatus or the like which does not have the program recommending function, the viewing information is stored into the viewing information storing unit in the storage 130.

It should be further understood by those skilled in the art that although the foregoing description has been made on embodiments of the invention, the invention is not limited thereto and various changes and modifications may be made without departing from the spirit of the invention and the scope of the appended claims.

1. A system including a digital broadcasting receiving apparatus and an information terminal apparatus, wherein:
said digital broadcasting receiving apparatus has a broadcasting receiving unit for receiving a digital broadcasting, a transmitting and receiving unit for transmitting and receiving information to/from said information terminal apparatus, and a displaying unit;
said information terminal apparatus has a communicating unit for transmitting and receiving information to/from said digital broadcasting receiving apparatus and a storage unit;
said digital broadcasting receiving apparatus transmits information regarding a program viewed by said digital broadcasting receiving apparatus to said information terminal apparatus;
said information terminal apparatus stores the received information regarding the viewed program into the storage unit and sets the stored information into storage viewing information;
when a process for allowing program information regarding a recommended program to a user to be displayed to said displaying unit is executed, said digital broadcasting receiving apparatus transmits a transmitting request of said storage viewing information stored in said storage unit of the information terminal apparatus to the information terminal apparatus;
the information terminal apparatus which received the transmitting request transmits the storage viewing information to the digital broadcasting receiving apparatus; and
on the basis of the received storage viewing information, the digital broadcasting receiving apparatus selects information of the program to be recommended to said user from program information received by said broadcasting receiving unit, that is, program information of programs which will be broadcasted in future and allows the selected information to be displayed to the displaying unit.

2. A system according to claim 1, wherein:
said digital broadcasting receiving apparatus receives storage viewing information also from a second information terminal apparatus different from said information terminal apparatus having the storage unit for storing the information regarding the viewing program; and
on the basis of the storage viewing information received from a plurality of information terminal apparatuses including said information terminal apparatus and said second information terminal apparatus, the digital broadcasting receiving apparatus allows the program information of the recommended program selected from the program information received by said broadcasting receiving unit to be displayed to the displaying unit.

3. A system according to claim 2, wherein the selection of the program information of the recommended program in said digital broadcasting receiving apparatus is performed on the basis of a collection result obtained by executing a collecting process for adding a weight to the storage viewing information received from a predetermined information terminal apparatus among the storage viewing information received from a plurality of information terminal apparatuses including said information terminal apparatus and said second information terminal apparatus.

4. A system including a digital broadcasting receiving apparatus and an information terminal apparatus, wherein:
said digital broadcasting receiving apparatus has a broadcasting receiving unit for receiving a digital broadcasting, a transmitting and receiving unit for transmitting and receiving information to/from said information terminal apparatus, and a displaying unit;
said information terminal apparatus has a communicating unit for transmitting and receiving information to/from said digital broadcasting receiving apparatus and a storage unit;
said digital broadcasting receiving apparatus transmits information regarding a program viewed by said digital broadcasting receiving apparatus to said information terminal apparatus;
said information terminal apparatus records collection information obtained by executing a collecting process on the basis of the received information regarding the viewed program into the storage unit;
when a process for allowing program information regarding a recommended program to a user to be displayed to said displaying unit is executed, said digital broadcasting receiving apparatus transmits a transmitting request of said collection information recorded in said storage unit of the information terminal apparatus to the information terminal apparatus;
the information terminal apparatus which received the transmitting request transmits the collection information to the digital broadcasting receiving apparatus; and
on the basis of the received collection information, the digital broadcasting receiving apparatus selects information of the program to be recommended to said user from program information received by said broadcasting receiving unit, that is, program information of programs which will be broadcasted in future and allows the selected information to be displayed to the displaying unit.

5. A system including a digital broadcasting receiving apparatus and an information terminal apparatus, wherein:
said digital broadcasting receiving apparatus has a broadcasting receiving unit for receiving a digital broadcasting, a transmitting and receiving unit for transmitting and receiving information to/from said information terminal apparatus, and a displaying unit;
said information terminal apparatus has a communicating unit for transmitting and receiving information to/from said digital broadcasting receiving apparatus and a storage unit;
said digital broadcasting receiving apparatus transmits information regarding a program viewed by said digital broadcasting receiving apparatus to said information terminal apparatus;
said information terminal apparatus stores the received information regarding the viewed program into the storage unit and sets the stored information into storage viewing information;
when a process for allowing program information regarding a recommended program to a user to be displayed to said displaying unit is executed, said digital broadcasting receiving apparatus transmits a transmitting request of collection information obtained by executing a collecting process to the storage viewing information stored in said storage unit of the information terminal apparatus to the information terminal apparatus;
the information terminal apparatus which received the transmitting request forms the collection information by executing the collecting process to the storage viewing information stored in said storage unit and transmits the collection information to the digital broadcasting receiving apparatus; and
on the basis of the received collection information, the digital broadcasting receiving apparatus selects information of the program to be recommended to said user from program information received by said broadcasting receiving unit, that is, program information of programs which will be broadcasted in future and allows the selected information to be displayed to the displaying unit.

6. A digital broadcasting receiving apparatus comprising:
a receiving unit for receiving a digital broadcasting;
a displaying unit;
an interface for connecting a detachable storage device; and
a recommended program selecting unit for selecting program information of a recommended program which is displayed to said displaying unit,
wherein information regarding a viewing program of a user of said digital broadcasting receiving apparatus is recorded into said storage device through said interface, and
the information regarding the viewing program of the user recorded in the storage device is reproduced, and on the basis of the reproduced information, said recommended program selecting unit selects the program information of the program to be recommended to the user from program information received by the receiving unit, that is, program information of programs which will be broadcasted in future, and allows the selected information to be displayed to the displaying unit.

7. An apparatus according to claim 6, wherein
even if the information regarding the viewing program of the user recorded in a storage device connected to said interface is information recorded by another digital broadcasting receiving apparatus different from said digital broadcasting receiving apparatus,
said digital broadcasting receiving apparatus reproduces the information regarding the viewing program of the user from the storage device, and
on the basis of the reproduced information, said recommended program selecting unit selects the program information of the program to be recommended to the user from program information received by the receiving unit, that is, program information of programs which will be broadcasted in future, and allows the selected information to be displayed to the displaying unit.

8. A system including a digital broadcasting receiving apparatus and an information terminal apparatus, wherein:
said digital broadcasting receiving apparatus has a broadcasting receiving unit for receiving a digital broadcasting and a transmitting and receiving unit for transmitting and receiving information to/from said information terminal apparatus;
said information terminal apparatus has a communicating unit for transmitting and receiving information to/from said digital broadcasting receiving apparatus, a storage unit, an obtaining unit for obtaining program information of a program which is broadcasted by a digital broadcasting, a recommended program selecting unit for selecting a program to be recommended to a user, and a displaying unit;
said digital broadcasting receiving apparatus transmits information regarding a program viewed by said digital broadcasting receiving apparatus to said information terminal apparatus;
said information terminal apparatus stores the received information regarding the viewed program into said storage unit and sets the stored information into storage viewing information; and
on the basis of said storage viewing information stored in said storage unit, said recommended program selecting unit selects program information of a program to be recommended to said user from the program information obtained by said obtaining unit and allows the selected program information to be displayed to the displaying unit.

9. An information terminal apparatus which can transmit instruction information to a digital broadcasting receiving apparatus, comprising:
an instruction transmitting unit for transmitting the instruction information to said digital broadcasting receiving apparatus;
a storage unit;
an obtaining unit for obtaining program information of a program which is broadcasted by a digital broadcasting;
a recommended program selecting unit for selecting a program to be recommended to a user; and
a displaying unit,
wherein said instruction transmitting unit transmits the instruction information for instructing a tuning to said digital broadcasting receiving apparatus,
said storage unit stores program information of a program whose tuning has been instructed by said instruction information and sets the stored information into storage viewing information,
on the basis of said storage viewing information stored in said storage unit, said recommended program selecting unit selects program information of the program to be recommended to the user from the program information obtained by said obtaining unit, and
said displaying unit displays the selected program information.

10. A digital broadcasting receiving apparatus comprising:
a broadcasting receiving unit for receiving a digital broadcasting;
an information receiving unit for receiving information from an external information terminal apparatus;
a displaying unit; and
a recommended program selecting unit for selecting program information of a recommended program which is displayed to said displaying unit,
wherein said information receiving unit receives the information which was formed in said external information terminal apparatus and which relates to a program viewing of a user,
on the basis of the information which was received through said information receiving unit and which relates to the program viewing of the user, said recommended program selecting unit selects information of a program to be recommended to said user from program information received by said broadcasting receiving unit, that is, program information of programs which will be broadcasted in future, and
said displaying unit displays the selected program information.

11. An information terminal apparatus comprising:
a communicating unit for receiving information from an external digital broadcasting receiving apparatus;
a storage unit;
an obtaining unit for obtaining program information of a program which is broadcasted by a digital broadcasting;
a recommended program selecting unit for selecting a program to be recommended to a user; and
a displaying unit,
wherein said communicating unit receives the information regarding a program which was viewed by said external digital broadcasting receiving apparatus from the external digital broadcasting receiving apparatus,
said storage unit records the received information regarding the viewed program or information formed on the basis of the information regarding the viewed program,
in accordance with the information recorded in said storage unit or information formed on the basis of the information recorded in said storage unit, said recommended program selecting unit selects program information of the program to be recommended to said user from the program information obtained by said obtaining unit, and
said displaying unit displays the selected program information.

12. A digital broadcasting receiving apparatus for receiving a digital broadcasting, comprising:
a broadcasting receiving unit for receiving the digital broadcasting; and
an information transmitting unit for transmitting information to an external information terminal apparatus,
wherein said information transmitting unit transmits information which was received through said broadcasting receiving unit and which relates to a program viewed by said digital broadcasting receiving apparatus to the external information terminal apparatus.

13. An information terminal apparatus comprising:
a communicating unit for transmitting and receiving information to/from an external digital broadcasting receiving apparatus; and
a storage unit,
wherein said communicating unit receives the information regarding a program which was viewed by said external digital broadcasting receiving apparatus from the external digital broadcasting receiving apparatus,
said storage unit records the received information regarding the viewed program or information formed on the basis of the information regarding the viewed program, and
said communicating unit transmits the information recorded in said storage unit or information formed on the basis of the information recorded in said storage unit.

14. A receiving method for digital broadcasting program used in a receiving apparatus including a broadcasting receiving unit for receiving a digital broadcasting, an information receiving unit for receiving information from an external information terminal apparatus, a displaying unit, and a recommended program selecting unit for selecting program information of a recommended program which is displayed to said displaying unit, the method comprising the steps of:
receiving, at said information receiving unit, information which was formed in said external information terminal apparatus and relates to a program viewing of a user,
selecting, at said recommended program selecting unit on the basis of the information which was received through said information receiving unit and relates to the program viewing of the user, information of a program to be recommended to said user from program information received by said broadcasting receiving unit, that is, program information of programs which will be broadcasted in future, and
displaying, at said displaying unit, the selected program information.

15. A transmission method for transmitting instruction information, used in an information terminal apparatus, to a digital broadcasting receiving apparatus, comprising the steps of:
transmitting, at an instruction transmitting unit, the instruction information to said digital broadcasting receiving apparatus;
obtaining, at an obtaining unit, program information of a program which is broadcasted by a digital broadcasting;
selecting, at a recommended program selecting unit, a program to be recommended to a user; and
wherein said instruction transmitting unit transmits the instruction information for instructing a tuning to said digital broadcasting receiving apparatus,
on the basis of said storage viewing information stored in a storage unit which stores program information of a program whose tuning has been instructed by said instruction information and sets the stored information into storage viewing information, said recommended program selecting unit selects program information of the program to be recommended to the user from the program information obtained by said obtaining unit, and
displaying, at a displaying unit, the selected program information.

16. A method used in an information terminal apparatus, comprising the steps of:
receiving, at a communicating unit, information from an external digital broadcasting receiving apparatus;
obtaining, at an obtaining unit, program information of a program which is broadcasted by a digital broadcasting;
selecting, at a recommended program selecting unit, a program to be recommended to a user; and
wherein said communicating unit receives the information regarding a program which was viewed by said external digital broadcasting receiving apparatus from the external digital broadcasting receiving apparatus,
in accordance with the information recorded in a storage unit which records the received information regarding the viewed program or information formed on the basis of the information regarding the viewed program, or information formed on the basis of the information recorded in said storage unit, said recommended program selecting unit selects program information of the program to be recommended to said user from the program information obtained by said obtaining unit, and
displaying, at a displaying unit, the selected program information.
